(19) United States
(12) Patent Application Publication
(10) Pub. No.: US 2016/0256883 A1
(43) Pub. Date: Sep. 8, 2016

(54) LIQUID DISPENSING SYSTEM WITH IMPROVED PRESSURE CONTROL

(71) Applicant: Wagner Spray Tech Corporation, Plymouth, MN (US)

(72) Inventors: Jeffrey Scott Jerdee, Brooklyn Park, MN (US); Shawn Cameron Johnson, Milaca, MN (US); Lam Huu Nguyen, Woodbury, MN (US)

(73) Assignee: Wagner Spray Tech Corporation

(21) Appl. No.: 15/057,608

(22) Filed: Mar. 1, 2016

Related U.S. Application Data
(60) Provisional application No. 62/127,037, filed on Mar. 2, 2015.

(51) Int. Cl. B05B 12/08; B05B 9/04

(52) U.S. Cl. CPC B05B 12/087; B05B 9/0403

(57) ABSTRACT

A liquid dispensing system is provided. The liquid dispensing system comprises a fluid applicator with an inlet and an outlet. The liquid dispensing system also comprises a fluid flow path comprising an inlet configured to couple to a fluid source on a first end, and the fluid applicator on a second end. The liquid dispensing system also comprises a pump system configured to drive flow of fluid from the fluid source along the fluid flow path to the fluid applicator. The liquid dispensing system also comprises a pressure relief system. The pressure relief system comprises a return line. The pressure relief system also comprises a pressure relief valve. The pressure relief system when actuated, is configured to actuate a pressure relief valve such that the return line receives a portion of fluid within the fluid flow path in response to a detected pressure proximate the fluid applicator.

### CROSS-REFERENCE TO RELATED APPLICATIONS

The present application is based on and claims the benefit of U.S. Provisional Patent Application Serial No. 62/127,037 filed Mar. 2, 2015, the content of which is hereby incorporated by reference in its entirety.

### BACKGROUND

A typical liquid dispensing system typically includes a fluid source, a pump, an applicator, and a line configured to deliver a dispensable fluid, from the fluid source, to the applicator. In a spraying application, a piston pump drives the dispensable fluid material through a line to the liquid applicator. As the fluid travels, a pressure drop is experienced across the length of the line, requiring the piston pump to operate such that the fluid enters the line at a higher pressure than a desired spray pressure.

The magnitude of the pressure drop experienced along the length of a delivery line depends on several factors, such as the viscosity of a material being pumped, an inner diameter of the delivery line, the length of the line, etc. It is important, in a spraying application, to maintain a consistent pressure at the liquid applicator such that the applicator can apply fluid at a desired spray pressure, such that a uniform texture or appearance is achieved.

### SUMMARY

A liquid dispensing system is provided. The liquid dispensing system comprises a fluid applicator with an inlet and an outlet. The liquid dispensing system also comprises a fluid flow path comprising an inlet configured to couple to a fluid source on a first end, and the fluid applicator on a second end. The liquid dispensing system also comprises a pump system configured to drive flow of fluid from the fluid source along the fluid flow path to the fluid applicator. The liquid dispensing system also comprises a pressure relief system. The pressure relief system comprises a return line. The pressure relief system also comprises a pressure relief valve. The pressure relief system when actuated, is configured to actuate a pressure relief valve such that the return line receives a portion of fluid within the fluid flow path in response to a detected pressure proximate the fluid applicator.

### BRIEF DESCRIPTION OF THE DRAWINGS

FIG. 1 is a diagrammatic view of one example liquid dispensing system in accordance with one embodiment of the present invention.

FIG. 2 is a diagrammatic view of an example pressure relief system in accordance with one embodiment of the present invention.

FIG. 3 is a flow diagram of a method for monitoring pressure within a liquid dispensing system in accordance with one embodiment of the present invention.

FIGS. 4A-4C illustrate a plurality of views of one example pump system for a liquid dispensing system in accordance with one embodiment of the present invention.

FIGS. 5A-C illustrate a plurality of views of one example pneumatic pressure relief system for a liquid dispensing system in accordance with one embodiment of the present invention.

FIGS. 6A-B illustrate a plurality of views of one example mechanical pressure relief system for a liquid dispensing system in accordance with one embodiment of the present invention.

### DETAILED DESCRIPTION OF ILLUSTRATIVE EMBODIMENTS

While aspects of the present disclosure describe a liquid dispensing system configured to dispense paint, as one example of a liquid dispensable by embodiments described herein, it is to be understood that at least some embodiments may be configured to accommodate other fluids, for example, a liquid dispensing system may be configured to dispense any of: aqueous solutions, oil-based solutions, solutions with texture components, varnish, etc. In at least one embodiment, liquid dispensing system is configured to dispense plural component materials. However, for the sake of illustration, the example of a liquid dispensing system configured to dispense paint will be described in further detail.

A liquid dispensing system, may comprise, in one embodiment, a pump, a fluid path, and an applicator. It is not uncommon for the pressure at a pump-end of a fluid path to be higher than a pressure experienced at the liquid applicator inlet while liquid is dispensed. However, when the liquid applicator is not actively releasing a flow of paint (for example when the system is on, with a spray nozzle closed) but the pumping system is still running, the fluid pressure will equalize along the flow path, and the static fluid pressure at the liquid applicator inlet will increase.

Actuating a dispensing system when an application pressure is too high, for example at the beginning of a paint spraying operation, can result in unintended fluid splatter, or an otherwise non-uniform distribution. In order to better maintain a constant pressure at the liquid applicator, a pressure relief system may be employed. In one embodiment, the pressure relief system is configured to vent some liquid and reduce pressure at the applicator using a pressure relief valve. A pressure relief system may, in one embodiment, assist in maintaining a constant pressure at the liquid applicator even when the applicator is not in a spraying configuration. Therefore, it is desired for a liquid dispensing system to include a pressure relief system configured to measure a pressure at the liquid applicator, in order to ameliorate an undesired increase in pressure, such that the liquid applicator operates at the desired pressure when a spraying operation resumes. In one embodiment, the pressure relief system is actuated only upon detection of an undesired pressure increase. In one embodiment, a pump motor control system receives the detection of the undesired pressure increase, and generates a signal for activation of the pressure relief system. For example, in one embodiment, a pressure sensor detects an undesired increase in pressure at the applicator, transmits the signal to a pump motor control system, which then signals a pressure relief system controller to activate the pressure relief system. In one embodiment, the pressure relief system is actuated when the applicator is in a non-spraying configuration, or when a pump motor is not actively pumping fluid.

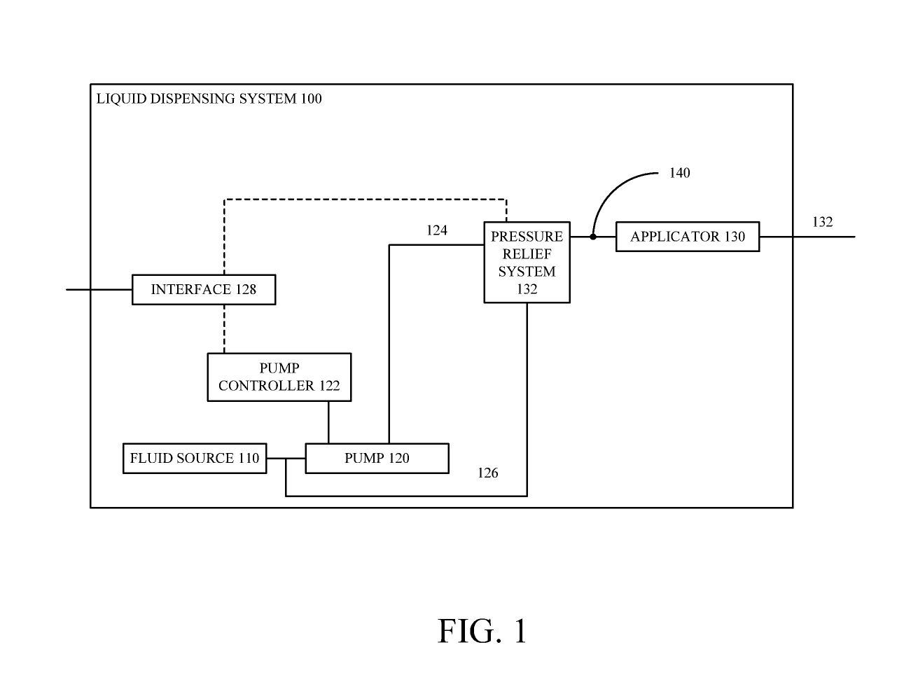

FIG. 1 is a diagrammatic view of one example liquid dispensing system in accordance with one embodiment of the present invention. Liquid dispensing system 100 may comprise, in one embodiment, fluid source 110, coupled to a pump 120 which is configured, in one embodiment, to provide fluid to an applicator 130. Applicator 130, in one embodiment, provides an output stream 132 at an operator-specified pressure, when actuated. In one embodiment, pump 120 is controlled by a pump controller 122. Pump controller 122 may control a motor that drives pump 120. Pump controller 122 may also include a pressure sensor configured to measure fluid pressure at the outlet of pump 120. Pump controller 122 may also be configured to receive an indication of fluid pressure at an applicator inlet. In one embodiment, pump controller 122 is in direct communication with a pressure sensor physically located at, or substantially near, applicator inlet 140. In another embodiment, pump controller 122 communicates with pressure relief system 132, which is in direct communication with a pressure sensor at or substantially near applicator inlet 140. In one embodiment, pressure relief system 132 is in an offline mode until a pressure increases is detected. In one embodiment, pressure relief system 132 can be actuated separately from pump controller 122. In one embodiment, pressure relief system 132 is active at substantially all times the pump controller 122 is active, such that signals from pump controller 122 can be received, and acted on, by pressure relief system 132. In one embodiment, pressure relief system 132 is actuated solely by signals sent from pump controller 132.

In one embodiment, pressure relief system 132 is coupled, either directly or through pump controller 122, to an interface 128. Interface 128 may comprise, in one embodiment, an input mechanism and an output mechanism such that an operator can input a desired spray pressure, or other relevant parameter, and view an output, for example, a display providing a current spray pressure or a current pump output pressure.

In one embodiment, a fluid path through liquid dispensing system 100 comprises a flow from fluid source 110 driven by a pump 120, to a liquid applicator 130 and through an outlet of a spray nozzle in order to provide the fluid in a desired spray pattern. The liquid dispensed by system 100 may, in one embodiment, be pressurized by pump 120 which may be either of an air-based pump (e.g. pneumatic pump) or airless pump (e.g., a piston pump). Liquid dispensing system 100 may, in one embodiment, be configured to provide fluid through a spray nozzle as tiny, atomized droplets. Therefore, the pressure along the fluid path is an important parameter for a liquid dispensing system 100, and governs the consistent and smooth distribution of a liquid on an application surface. Due to friction losses, the pressure decreases along a length of a delivery line 124. The pressure drop may require liquid dispensing system 100 to operate a pump at a higher output pressure than that desired at an inlet of a liquid applicator. For instance, a fluid pressure at the outlet of pump 120 can be much higher than a desired spray pressure for a given fluid dispensing operation.

The magnitude of pressure drop along delivery line 124 depends on several factors that include, but are not limited to: paint viscosity, inside diameter of delivery line 124, and length of delivery line 124. However, when the spray nozzle is closed, the pressure at an inlet 140 of liquid applicator 130 may increase, causing the difference in pressure between the pressure at the outlet of pump 120, and the pressure at inlet 140 to decrease. In one embodiment, in order to maintain a constant pressure at inlet 140, a pressure relief system, such as pressure relief system 132 is configured to vent paint from delivery line 124, to return line 126, using a pressure relief valve, for example, pressure relief valve 216. As a result, pressure relief system 132 may assist in maintaining a constant pressure difference between the pressure at the outlet of pump 120 and the pressure at inlet 140.

In one embodiment, during normal operation of liquid dispensing system 100, pressure relief system 132 may be substantially non-operational, as pump controller 122 may be configured to drive pump 120 to provide fluid through delivery line 124 such that it reaches applicator 130 at a desired pressure. However, in one embodiment, pressure relief system 132 is configured to detect that delivery line 124 is delivering fluid to applicator 130 at a higher than desired pressure. In response, in one embodiment, pressure relief system 132 may operate to allow some fluid to return along return line 126. Removal of some of the volume of fluid from delivery line 124 may return pressure at inlet 140 to a desired pressure for a given operation. Pressure relief system 132 may, then, assist in providing an output stream 132 at the desired spray pressure. In another embodiment, pressure relief system 132 is in substantially continuous operation while pump 120 is in operation, monitoring an indicated pressure at applicator inlet 140, and venting fluid as needed to maintain a desired spray pressure for a given paint application.

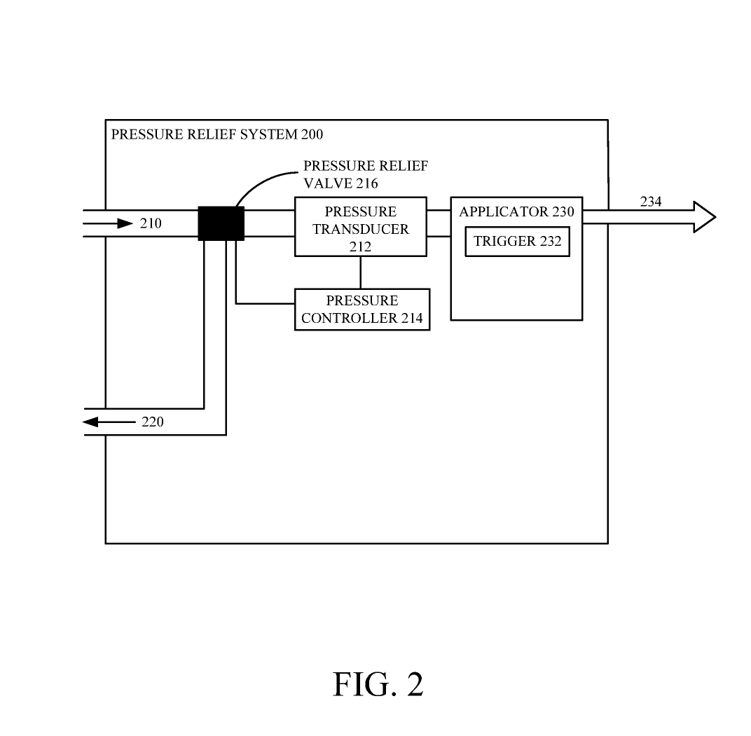

In one embodiment, pump controller 132 is configured to receive an indication from a pressure sensor physically located proximate inlet 140 of a detected applicator pressure. Upon receiving an indication that the detected applicator pressure is higher than a threshold applicator pressure, pump controller 132 actuates pressure relief system 132. Actuation of pressure relief system 132, in one embodiment, comprises sending a signal to a pressure relief system controller (for example, controller 214 discussed in greater detail in FIG. 2), which, upon receipt of the signal, actuates pressure relief system. In another embodiment, pressure relief system 132 is configured to receive an indication of a detected applicator pressure at inlet 140 and, independently, vent fluid along return line 126. In another embodiment, control of pressure relief system 132 is at least partially shared by pump controller 132 and a pressure relief system controller.

Pressure relief system 132, in one embodiment, is physically proximate liquid applicator 130 such that it can accurately detect a fluid pressure at inlet 140. Pressure relief system 132, in one embodiment, communicates directly with pump controller 122 in order to ensure that delivery line 124 delivers fluid at the correct pressure to applicator 130. In the event that applicator 130 is in a closed configuration, in one embodiment, pressure relief system 132 is configured to detect an increase in pressure at inlet 140 and communicate that increase to pump controller 122. Pump controller 122, in one embodiment, is configured to send a signal to pressure relief system 132, indicating some fluid should be diverted to return line 126. In another embodiment, pressure relief system 132, upon detecting an unacceptable increase in fluid pressure at inlet 140, will automatically take action to return fluid pressure at inlet 140 to a desired threshold, for example by venting some fluid along return line 126. In one embodiment, once the static pressure at inlet 140 returns to an acceptable threshold, pressure relief system 132 may resume normal operation.

FIG. 2 is a diagrammatic view of an example pressure relief system in accordance with one embodiment of the present invention. Pressure relief system 200, in one embodiment, may be substantially similar to pressure relief system 132, described above with respect to FIG. 1. Pressure relief system 200 may, in one embodiment, be located within a liquid dispensing system, for example liquid dispensing system 100 described above. Pressure relief system 200, in one embodiment, is configured to monitor various parameters for delivery stream 210, for example, driven by a pump 120. In one embodiment, pressure relief system 200 is configured to monitor fluid pressure at an inlet to applicator 230. Pressure relief system 200, when actuated, may control a volume of fluid through a return stream 220.

In one embodiment, return stream 220 is configured to return back to an inlet stream from a junction near applicator 230 for recirculation through a liquid dispensing system. In another embodiment, return stream 220 is configured to provide some fluid back to a fluid source, for example fluid source 110, described above with respect to FIG. 1. In another embodiment, return stream 220 is configured to provide fluid to a waste stream. In one embodiment, fluid is urged along return line 220 by built-up pressure within delivery stream 210. In another embodiment, fluid moves along return line 220 with the assistance of a pump or other mechanical driving force provided by a liquid dispensing system, a pressure relief system, or another appropriate mechanical source.

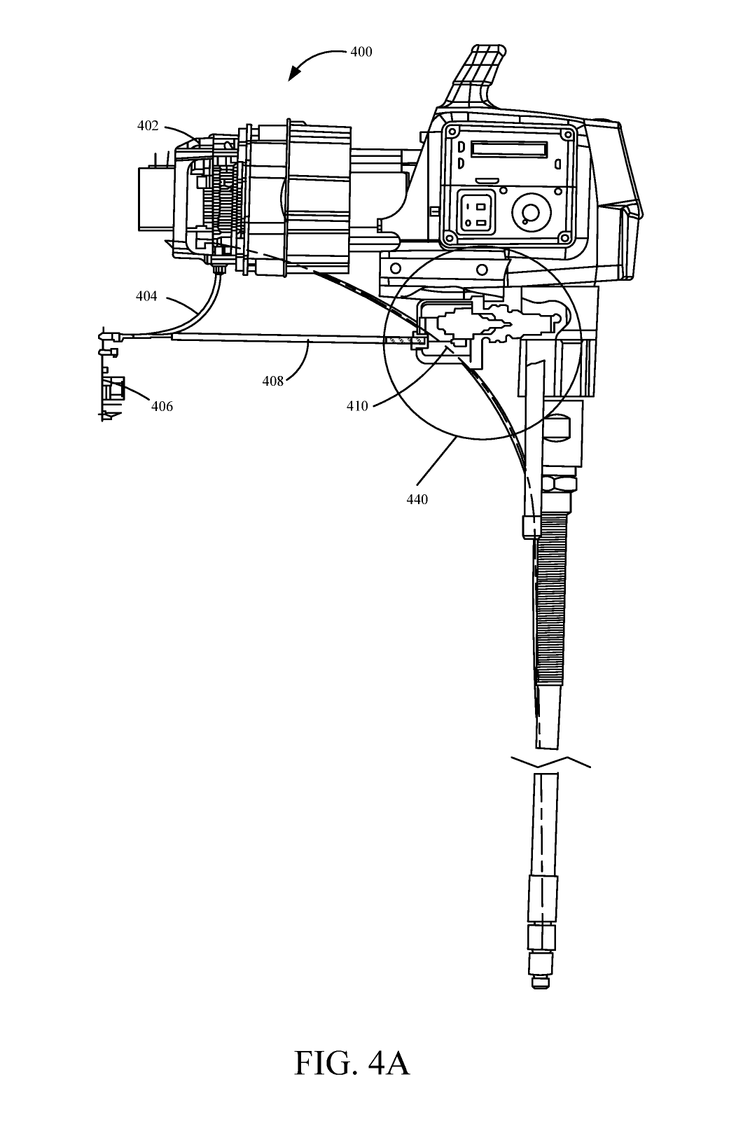

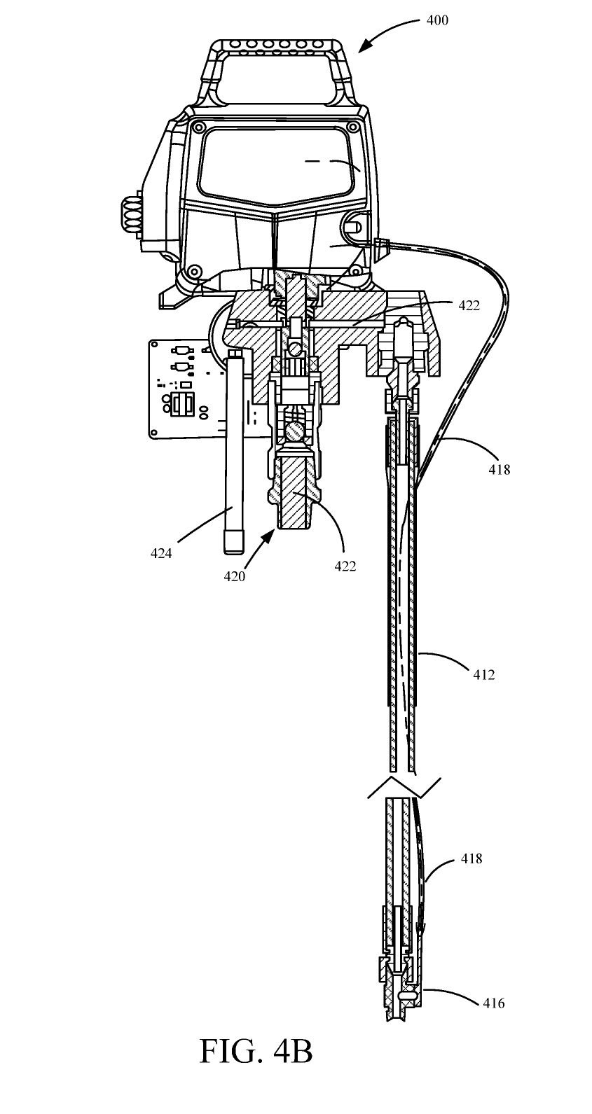

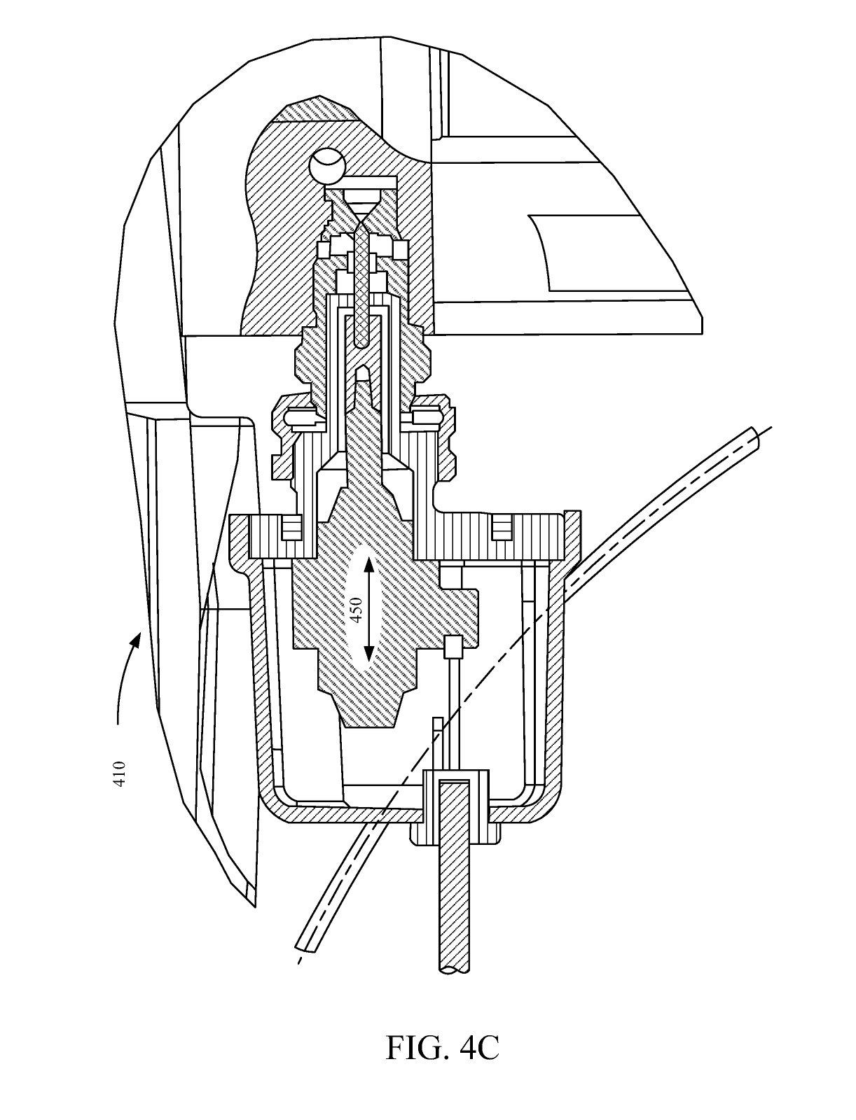

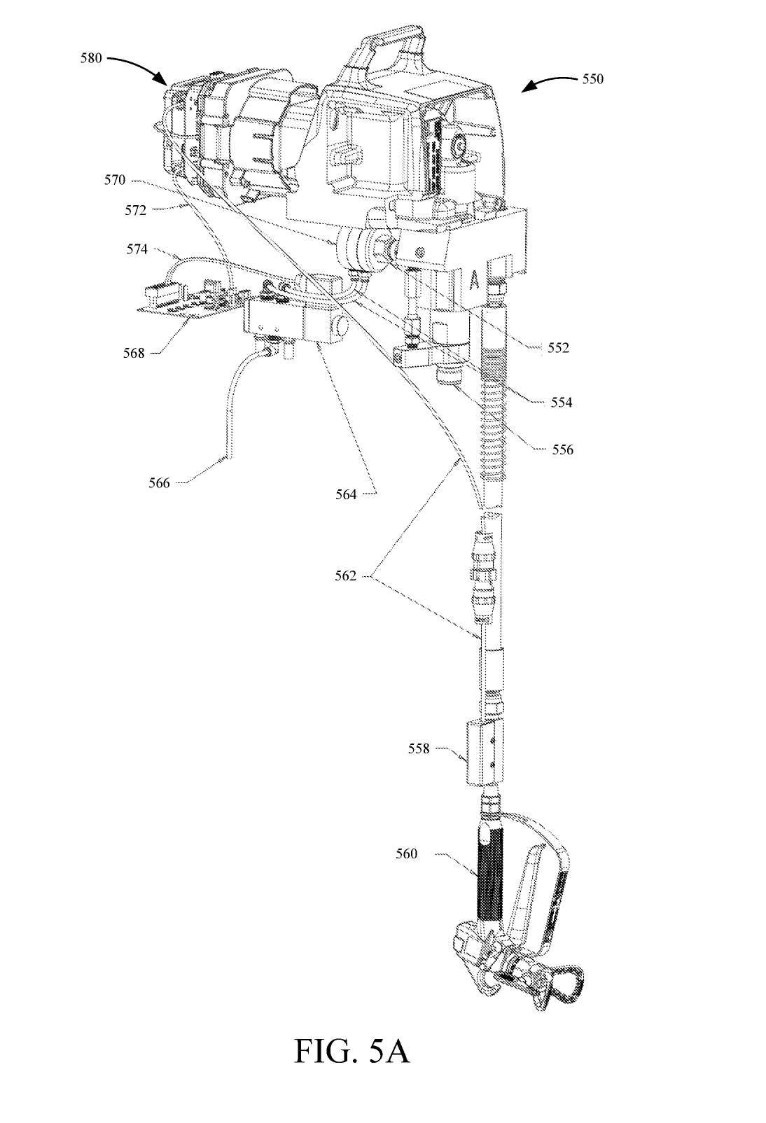

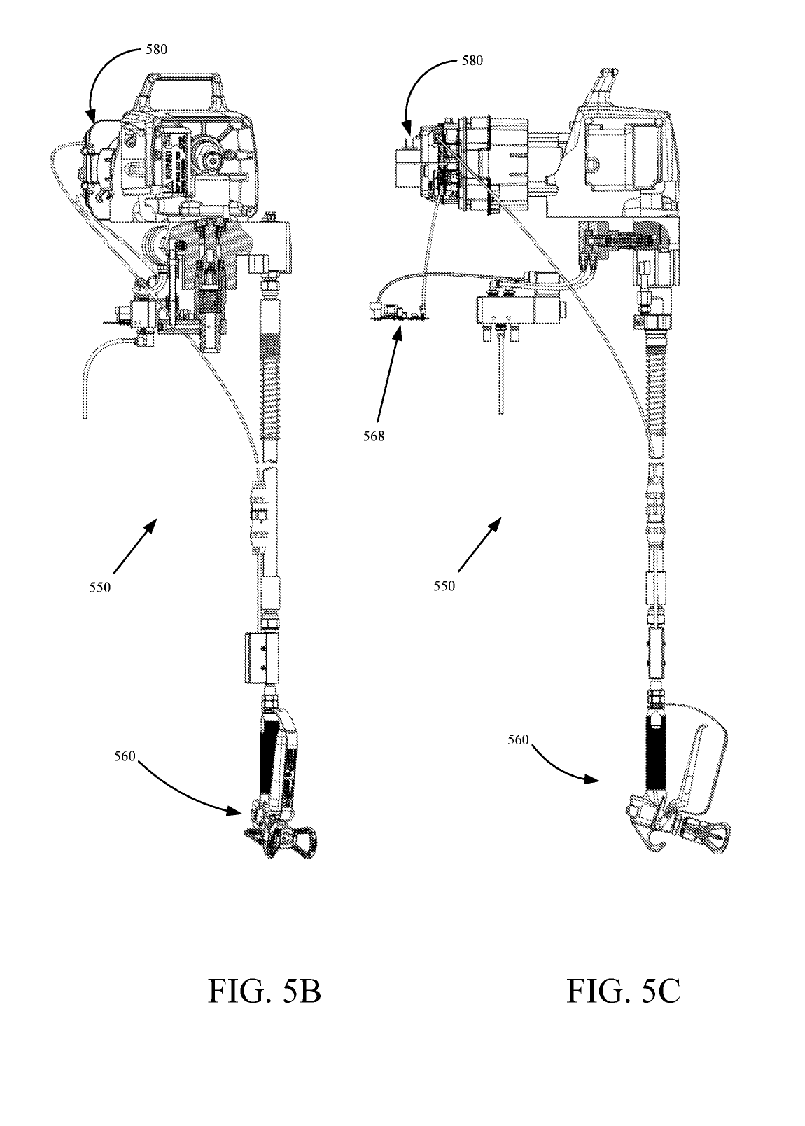

In one embodiment, pressure relief system 200 comprises a pressure transducer 212 that is configured to measure pressure at, or substantially near, an inlet to applicator 230. Pressure relief system 200 may also comprise a pressure relief valve 216. In one embodiment, for example that shown in FIG. 2, pressure relief valve 216 is located upstream from pressure transducer 212, such that, when actuated, pressure relief valve 216 vents fluid along return stream 220, before the fluid would otherwise encounter pressure transducer 212. While FIG. 2 illustrates a pressure relief valve 216 substantially proximate pressure transducer 212, it is to be understood that this is for purposes of illustration only. In another embodiment, for example that illustrated in FIGS. 4 and 5 below, valve 216 is located near a pump-end of a delivery line, for example, to reduce a necessary length of return line 126. However, in another embodiment, pressure relief valve 216 may be located upstream from the pressure transducer 212, such that it is physically located between pressure transducer 212 and applicator 230. In another embodiment, pressure relief valve 216 may be connected to a component of applicator 230, such that delivery fluid 210 is delivered into an applicator 230 before being vented to return stream 220 by pressure relief valve 216.

In one embodiment, pressure relief system 200 comprises a controller 214. In another embodiment, pressure relief controller 214 operates, at least in part, based on signals sent by a pump controller, for example controller 122, described above with respect to FIG. 1. In one embodiment, controller 214 is pump controller 122, such that only one controller controls operations within a liquid dispensing system 100. In another embodiment, controller 214 operates independently from controller 122.

In one embodiment, pressure relief system controller 214 is automatically activated upon detection of a pressure at an inlet of applicator 230 higher than a preset fluid inlet pressure threshold. In one embodiment, activation of pressure relief system controller 214 is triggered by a signal from pump controller 122. In one embodiment, activation of pressure relief system controller 214 is triggered based on a indication received directly from pressure transducer 212. In one embodiment, the preset inlet fluid pressure threshold is substantially that of a desired spray pressure of an output stream 234 of applicator 230. For example, the desired threshold may be specified by an operator through an input mechanism on a user interface (e.g. interface 128 described above with respect to FIG. 1) of a liquid dispensing system coupled, for example, to controller 122, described in FIG. 1, or coupled to controller 214. However, in another embodiment, the pressure threshold may be preset by a manufacturer. In one embodiment, there may be multiple presets, such that the pressure relief system 200 cannot exceed a manufacturer set inlet fluid pressure threshold regardless of an operator set threshold, but an intermediate threshold may be set by an operator based on the parameters of a given paint operation such that the threshold set comprises a pressure setting above a minimum pressure required for functional use of applicator 230.

In one embodiment, pressure relief system controller 214, upon detecting that a pressure sensed by pressure transducer 212 is greater than a desired threshold, is configured to activate pressure relief system 200. In another embodiment, pressure relief system controller 214 is configured to activate pressure relief system 200 in response to a control signal received from controller 122, which may be based on a detected pressure indication from transducer 212. Activating pressure relief system 200, in one embodiment, comprises opening a pressure relief valve 216 configured to vent some fluid along return line 220. In another embodiment, actuating pressure relief system controller 214 comprises communicating with a pump motor controller, for example controller 122, in order to reduce the pressure of a pump output, for example by temporarily ceasing operation of the pump. In one embodiment, activating pressure relief valve 216 comprises partially or fully opening pressure relief valve 216 such that a volume of fluid may be received along return line 220. In one embodiment, return line 220 is defined by a diameter that is smaller than that of delivery line 210. In another embodiment, delivery line 210 and return line 220 comprise the same diameter, and are configured to circulate similar volumetric flow rates of fluid. In a further embodiment, return line 220 comprises a larger diameter than that of delivery line 210.

In one embodiment, applicator 230 comprises a trigger 232 configured to receive applied pressure from an operator and, in response, facilitate release of output stream 234 from applicator 230. In one embodiment, trigger 232 is pressure-sensitive, such that different applied pressures will release output streams 234 of different volumetric flow rates. In another embodiment, actuation of trigger 232 releases a constant-pressure spray of fluid, regardless of an applied pressure.

In one embodiment, pressure relief valve 216 is in fluidic communication with return line 220 near the liquid applicator 230. Pressure relief valve 216, in one embodiment, is configured to open and divert fluid from a delivery line 210, and close to allow fluid to continue along an intended fluid path through the liquid dispensing system, for example to applicator 230. In one embodiment, pressure transducer 212 is located in close physical proximity to applicator 230, and is configured to detect a fluid pressure substantially at an inlet of applicator 230. In one embodiment, if the pressure detected is greater than a threshold value, pressure transducer 212 is configured to generate and send a signal indicative of the detected pressure to a controller, for example motor controller 122, described above with regard to FIG. 1, or pressure relief controller 214, or another controller within a liquid dispensing system. The controller, in one embodiment, may then relay the pressure signal to a pressure relief system controller, for example controller 214, which, in response, may actuate pressure relief valve 216. In another embodiment, pressure relief system controller 214 is directly responsible for controlling actuation of pressure relief valve 216, for example, based on a detected pressure. In one embodiment, pressure transducer 212 is configured to periodically detect and report indications of detected fluid pressure values to a controller. In one embodiment, pressure transducer 212 reports detected pressure indications directly to pump controller 122. In another embodiment, pressure transducer 212 reports detected pressure indications directly to pressure relief system controller 214. In one embodiment, pump controller 122, upon detecting an undesired pressure increase, activates pressure relief system 200. Activating pressure relief system 200, comprises energizing pressure relief system 200. Activating pressure relief system 200, in one embodiment, comprises bringing pressure relief system 200 out of an inactive, dormant, or offline mode, into an online mode. In another embodiment, pressure relief system 200 is in an online mode when the pump controller 122 is online.

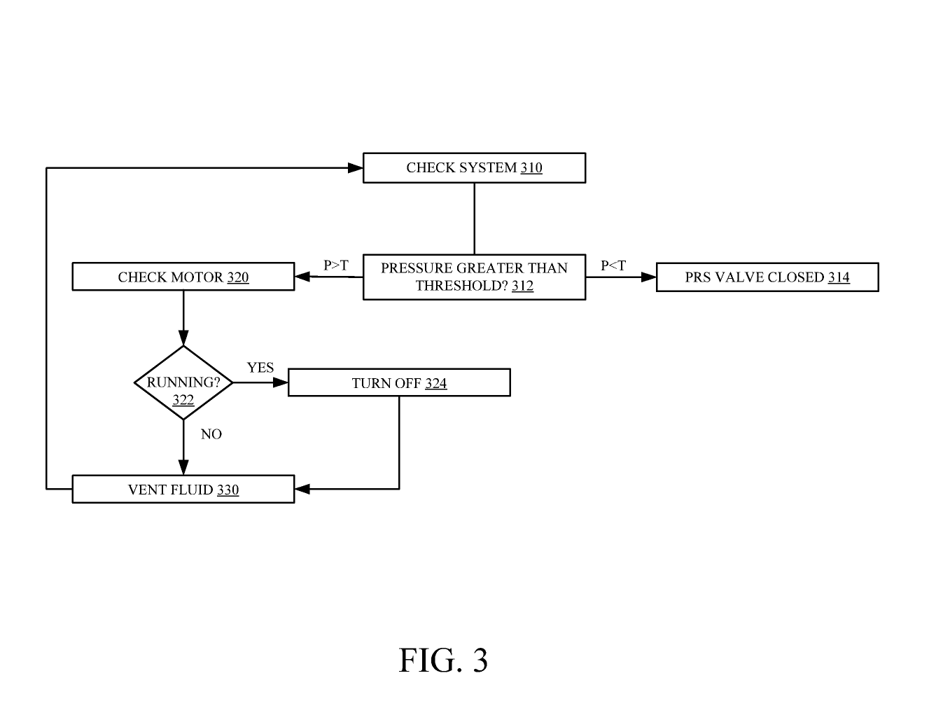

FIG. 3 is a flow diagram of a method for monitoring pressure within a liquid dispensing system in accordance with one embodiment of the present invention. Method 300 may be useful during a painting application, for example, to maintain acceptable pressure both at a pump outlet and applicator inlet. In another embodiment, method 300 is only implemented when a liquid dispensing system is not actively dispensing fluid, for example, when static pressure is most likely to build at a liquid applicator inlet. In one embodiment, method 300 is implemented by a controller within the liquid dispensing system, for example a pump motor controller, a pressure relief system controller, or another appropriate system controller.

block 310, a status of a liquid dispensing system is checked. In one embodiment, checking the system comprises a system controller receiving an indication of an applicator inlet fluid pressure. The indication may be detected, for example, by a pressure transducer in close physical proximity to, or substantially at, the applicator inlet. In one embodiment, the detected pressure indication is provided to a pressure relief system. In another embodiment, the detected pressure indication is provided directly to a system pump controller.

In block 312, the detected pressure is compared to a desired spray pressure threshold. The threshold may be, for example an operator-selected threshold, or a manufacturer preset threshold. The threshold for comparison may be based on operator input, for example, and may vary based on a fluid being dispensed, a spraying application, etc. In one embodiment, the operator sets a threshold directly, for example through a user interface of a liquid dispensing system. In another embodiment, the operator may select between manufacturer-set threshold settings, for example between “low,” “medium,” or “high” options.

In block 320, a motor status is checked. In one embodiment, checking the motor status comprises checking a status of a pump and/or a pump motor within a liquid dispensing system. In another embodiment, checking the motor comprises checking a run time of the pump, for example detecting a time period that the pump has been running after a spray nozzle is switched to a closed configuration. In another embodiment, checking the motor status comprises checking to determine whether a pump system has reached a steady state operation, or whether pressure within a line has reached equilibrium.

In block 324, if a motor is detected as running in decision block 322, the pump motor stops operation. In one embodiment, a high pressure scenario can be relieved while a pump motor is running, however that may require a system to work harder to vent fluid to maintain a desired spray pressure. Therefore, in at least one embodiment, prior to actuation of a pressure relief valve, operation of a pump motor at least temporarily ceases, for example until the high pressure scenario is resolved.

In decision block 330, fluid is vented to relieve a detected high pressure scenario. In one embodiment, venting fluid comprises checking a status of the pressure relief valve to determine whether the pressure relief valve is open or closed. In another embodiment, checking the status comprises detecting how far the valve must be opened, for example, to calculate or verify a volumetric flow rate of fluid moving through the pressure relief valve. In one embodiment, the pressure relief valve remains in a closed configuration until a pump is engaged, and may only be actuated to an open, or partially-open configuration to relieve a detected fluid pressure increase at an applicator inlet.

Actuating a pressure relief valve, as indicated in block 330, may comprise, in one embodiment, causing pressure relief system to fully, or partially, open a pressure relief valve. In one embodiment, a command to pressure relief system to actuate the pressure relief valve may originate from a pump, or system, controller. In another embodiment, the pressure relief system actuates the pressure relief valve in response to a received signal from a pressure transducer indicating an undesired pressure at the applicator inlet.

In one embodiment, opening a valve comprises partially opening a valve, for example, based on a volume of fluid that must be vented to achieve a desired pressure at an applicator inlet. In one embodiment, opening a pressure relief valve comprises actuating pressure relief valve such that a preset fluid volume returns or recirculates, for example, through a return line. The preset may comprise, for example, a time period configured to allow a desired volume of fluid to be vented, where the time period is calculated, for example by a system controller (e.g. either of the pressure relief system controller or a pump motor controller), based on a time required to vent a volume of fluid, where the time corresponds to a volume required to resolve a detected pressure differential between desired and detected applicator inlet pressure. In another embodiment, the relief valve is placed in an open configuration until a signal is received to return it to a closed configuration. The signal may, in one embodiment, originate from a pump motor controller. In another embodiment, the signal originates from a pressure relief system controller. In a further embodiment, the signal originates, at least in part, in response to an operator input. In another embodiment, the relief valve is configured to open for a preset period of time and then close. The signal, in one embodiment, may indicate a single cycle between a closed and open valve position. In another embodiment, the signal may indicate a repeat between an open and closed valve configuration until a desired inlet pressure is detected.

The method may, in one embodiment, return to block 310, to check an applicator pressure after some fluid has vented. In one embodiment, the cycle between blocks 310, 312, 322, and 330 continues until a pressure at the liquid applicator is reduced to, or below, a threshold. The cycle between blocks 310, 312, 322 and 330 may also periodically repeat as long as a spraying operation is on-going, and a liquid dispensing system is operational. For example, to ensure that the pressure at the liquid applicator does not rise above the threshold again. In one embodiment, the fluid pressure threshold comprises a range of acceptable pressure values, for example within 5 PSI, or within 10 PSI, of a desired fluid pressure.

FIGS. 4A-4C illustrate a plurality of views of one example pump system in accordance with one embodiment of the present invention. FIG. 4A depicts a side view of a liquid dispensing system 400 with a pressure relief system. FIG. 4B depicts a frontal view of the liquid dispensing system 400. Liquid dispensing system 400 includes a pump motor controller 402, a pressure relief system controller 406, a pressure relief valve 410, a fluid line 412, a pressure transducer 416, a pressure transducer cable 418, and a pump fluid inlet 420.

According to one embodiment, fluid, e.g. paint, is drawn from a reservoir (not shown in FIGS. 4A or 4B) into a pump fluid inlet 420, using a pump, for example a piston pump driven by a pump motor. Paint travels along fluid path 422, defined on one end by a pump fluid inlet 420, and continues along fluid path 422 inside line 412. In one embodiment, as fluid travels along the fluid path 422, a nozzle (not shown in FIGS. 4A or 4B) on a liquid applicator (not shown in FIGS. 4A or 4B) is in an open configuration, and the pressure inside line 412 decreases as fluid travels from a pump end to an applicator end of the fluid path 422. To maintain the desired spray pressure, the pressure at the pump outlet is maintained at a magnitude greater than the pressure at an applicator inlet to overcome friction losses. However, when the nozzle is actuated into a closed configuration, the pressure at the applicator inlet may increase, even above the desired spray pressure value. Then, when the nozzle is subsequently replaced in an open configuration, and a trigger actuated, the fluid flow from the applicator outlet may dispense at a pressure value greater than the desired spray pressure value, causing an inconsistent distribution of paint on a desired surface, or even splatter on undesired surfaces.

In one embodiment, when pump motor controller 402 has stopped a pump system from circulating paint, pressure transducer 416, located in close proximity to the liquid applicator (e.g., near the end of line 412, as shown in FIG. 4B), is configured to detect an indication of fluid pressure substantially at the liquid applicator inlet. Pressure transducer 416, in one embodiment, is coupled to pump motor controller 402 such that controller 402 receives indications of applicator pressure and, in response, controls the desired fluid spray pressure. In another embodiment, pressure transducer 416 is coupled directly to pressure relief system controller 406, which is configured to control the desired spray pressure of an applicator. The desired spray pressure value can depend, in one embodiment, on several factors including, but not limited to: the specific fluid dispensed, the application surface, and the environment surrounding the surface. In the event the pressure at an applicator inlet is greater than the desired spray pressure when the nozzle is closed, pump motor controller 402 is configured to send a signal to pressure relief system controller 406. The signal may, in one embodiment, be sent through a physical cable (e.g., communication cable 404) or, in another embodiment, the signal is sent wirelessly.

In one embodiment, when pressure relief system controller 406 receives a signal from pump motor controller 402, it is configured to send an actuating signal to open pressure relief valve 410. The actuating signal may be sent over a physical cable (e.g., communication cable 408), in one embodiment, or wirelessly, in another embodiment. In one embodiment, when the pressure relief valve opens, some paint located in fluid path 422 is diverted through fluid return line 424. Fluid return line 424 may be configured, in one embodiment, to dispense the vented paint into the reservoir, another suitable paint dispenser, a waste line, or return to inlet 420.

As the paint is diverted from fluid path 418 to a fluid return line 424, the pressure at the applicator inlet decreases. In one embodiment, if the pressure at an applicator inlet is still greater than the desired spray pressure, as measured by pressure transducer 416, a continued signal may be sent, for example to either of controller 402 and/or controller 406. In one embodiment, sending a continued signal comprises a signal to continue keeping pressure relief valve 410 open. However, once the applicator inlet pressure is equal to the desired spray pressure, pump motor controller 402 may, in one embodiment, discontinue sending a signal to pressure relief system controller 406, and pressure relief system controller 406 may actuate closure of pressure relief valve 410 and pressure relief valve 410.

FIG. 4C depicts an enlarged view of a pressure relief valve 410 that may correspond to valve view 440 indicated in FIG. 4A. In one embodiment, pressure relief valve 410 is configured to move along a valve axis 450. In one embodiment, actuating pressure relief valve 410 comprises moving pressure relief valve 410 from a completely closed position to a completely opened position. In one embodiment, actuating pressure relief valve 410 comprises moving pressure relief valve 410 through a series of positions along valve axis 450, for example allowing different flow rates of fluid to be diverted from a delivered line of fluid to a return fluid line.

FIGS. 5A-C illustrate a plurality of views of one example pneumatic pressure relief system for a liquid dispensing system in accordance with one embodiment of the present invention. FIGS. 5A, 5B and 5C illustrate, respectively, a perspective view, front view, and side view of a pump system with a pneumatic pressure relief system.

FIG. 5A illustrates one example pneumatically-operated pressure relief system. In one embodiment, pneumatic pump system comprises a spray gun 560 in physical proximity to pressure transducer 558. Pressure transducer 558, in one embodiment, is coupled to a communication cable 562, and is configured to transmit indications of detected applicator inlet pressures. In one embodiment, for example as shown in FIG. 5A, cable 562 is communicably coupled to motor controller 580. In response to a received pressure indication above a desired threshold, motor controller 580 sends a command to pressure relief system controller 568, for example over communication cable 572. In response to the received command, in one embodiment, pressure relief system controller 568 actuates pressure relief valve 552. FIG. 5A illustrates an embodiment where the pressure relief system is pneumatically operated. Air shuttle tubes 554 deliver air, or another exemplary gas, for example from air supply tube 566 to air cylinder 570. In one embodiment, when actuated, pressure relief controller 568 actuates a solenoid valve 565, to open pressure relief valve 552.

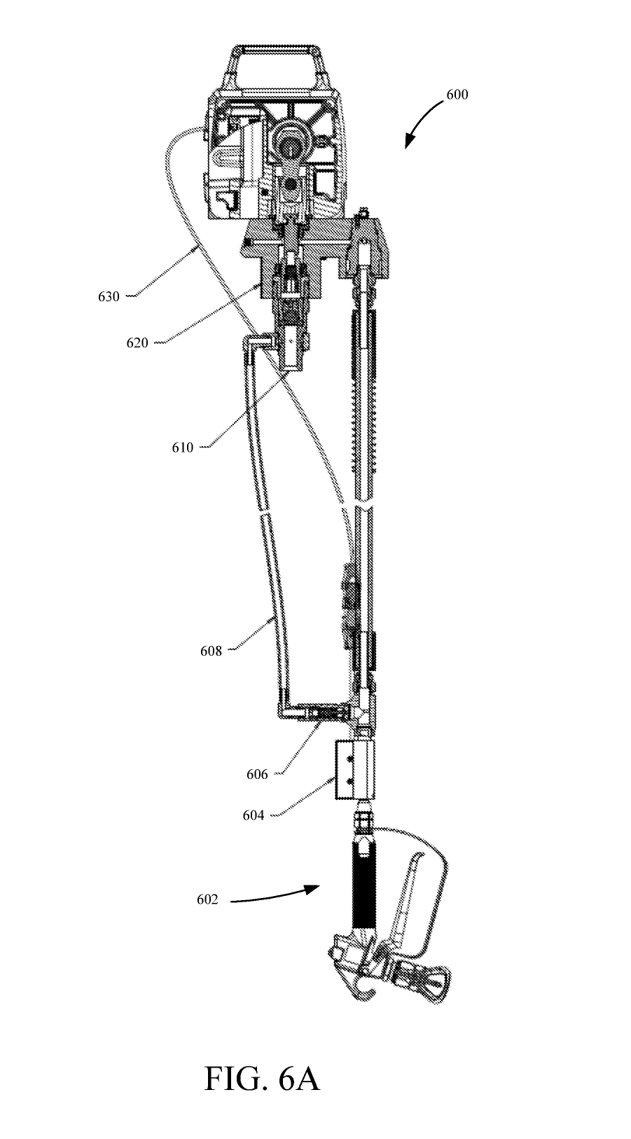

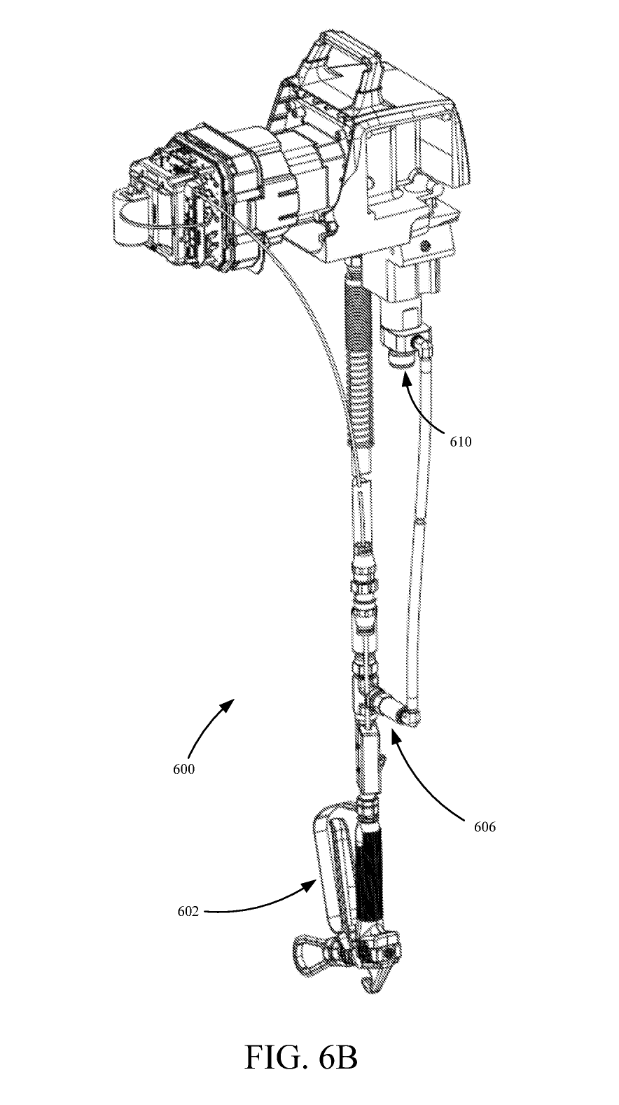

FIGS. 6A-B illustrate a plurality of views of one example mechanical pressure relief system for a liquid dispensing system in accordance with one embodiment of the present invention. While previous embodiments described herein envision either of an electrically-operated, or pneumatically-operated, pressure relief system, it is also envisioned that other pressure relief system configurations are possible. For example, a mechanically-controlled pressure relief system within a liquid dispensing system 600 is also envisioned. Liquid dispensing system 600 may comprise, in one embodiment, a spray gun 602 proximate a pressure sensor 604. Pressure sensor 604 may communicate with a controller through communication cable 630. Based on received pressure indications, for example, the controller may send commands to pump 620, spray gun 602, and/or valve 606. In one embodiment, a pressure metering valve 606, for example a ball and spring, or other suitable configuration, is situated proximate valve 606 such that sufficient pressure build-up causes the valve to open, until the pressure is relieved, at which time pressure relief system may receive a command to close the valve. Fluid may vent, through valve 606, through return line 608, such that vented fluid returns to an inlet valve 610. In one embodiment, the command to close the valve originates with a motor controller, for example based on a detection that the pressure at the applicator is at a desired spray pressure. In one embodiment, valve 606 closes automatically, when the pressure is relieved.

Although the present invention has been described with reference to preferred embodiments, workers skilled in the art will recognize that changes may be made in form and detail without departing from the spirit and scope of the invention.

What is claimed is:

1. A liquid dispensing system comprising:
a fluid applicator with an inlet and an outlet;
a fluid flow path comprising an inlet configured to couple to a fluid source on a first end, and the fluid applicator on a second end;
a pump system configured to drive flow of fluid from the fluid source, along the fluid flow path, to the fluid applicator; and
a pressure relief system comprising:
a return line;
a pressure relief valve; and
wherein the pressure relief system, when actuated, is configured to actuate a pressure relief valve such that the return line receives a portion of fluid within the fluid flow path in response to a detected pressure proximate the fluid applicator.

2. The liquid dispensing system of claim 1, wherein the pump system comprises a motor and a pump controller.

3. The liquid dispensing system of claim 2, wherein the pump controller is configured to receive an indication of the detected pressure, compare the indication to a pressure threshold and, in response to a determination that the detected pressure is greater than a pressure threshold, generate an actuation signal for the pressure relief valve.

4. The liquid dispensing system of claim 2, wherein the actuation signal is sent from the pump controller to a pressure relief system controller, which causes the pressure relief system to actuate the pressure relief valve.

5. The liquid dispensing system of claim 1, wherein the pressure relief system further comprises a pressure transducer, and wherein the detected pressure proximate the applicator comprises a fluid pressure at the inlet.

6. The liquid dispensing system of claim 1, wherein the pressure relief system further comprises a pressure relief system controller, and wherein the pressure relief system controller is configured to generate an actuation signal for the pressure relief valve in response to the detected pressure.

7. The liquid dispensing system of claim 5, wherein the pressure relief system controller is configured to receive an indication of the detected pressure, compare the indication to a pressure threshold and, in response to a determination that the detected pressure is greater than a pressure threshold, generate the actuation signal for the pressure relief valve.

8. The liquid dispensing system of claim 1, wherein actuating the pressure relief valve comprises moving the pressure relief valve from a closed configuration to an open configuration.

9. The liquid dispensing system of claim 8, wherein moving from the closed configuration to the open configuration comprises moving through, and selecting a partially open configuration.

10. The liquid dispensing system of claim 1, wherein the liquid dispensing system is configured to dispense plural component materials.

11. A pressure relief system for a liquid dispensing system, comprising:
a pressure sensor configured to sense a fluid pressure within a delivery flow path;
a controller configured to receive the sensed fluid pressure and compare the sensed fluid pressure to a threshold fluid pressure;
a pressure relief valve configured to provide a coupling between the delivery flow path and a return flow path; and
wherein, upon determining that the sensed fluid pressure is greater than the threshold fluid pressure, actuating the pressure relief valve such that a portion of fluid within the delivery flow path is provided to the return flow path.

12. The pressure relief system of claim 11, wherein the pressure sensor is disposed proximate an applicator and wherein the sensed fluid pressure is substantially a fluid pressure at an inlet of the applicator.

13. The pressure relief system of claim 11, wherein actuating the pressure relief valve comprises switching the pressure relief valve from a closed configuration to an open configuration.

14. The pressure relief system of claim 11, wherein the controller is configured to periodically receive and compare a plurality of sensed fluid pressure signals to the threshold fluid pressure.

15. The pressure relief system of claim 11, wherein the threshold fluid pressure comprises an operator-specified fluid pressure at an applicator inlet.

16. The pressure relief system of claim 11, wherein the threshold fluid pressure comprises a manufacture-specified fluid pressure at an applicator inlet.

17. A method for regulating a liquid applicator inlet pressure within a liquid dispensing system, the method comprising:
receiving an indication of a fluid pressure at an inlet of the liquid applicator;
comparing the indicated fluid pressure to a threshold inlet pressure; and
actuating a pressure relief system, based on a determination that the indicated fluid pressure is greater than the threshold inlet pressure, wherein actuating the pressure relief system comprises venting a portion of fluid from a delivery line to a return line.

18. The method of claim 17, and further comprising:
repeating the steps of receiving an indication and comparing the indicated fluid pressure to the threshold inlet pressure until the indicated fluid pressure is equal to or less than the threshold inlet pressure; and
returning the pressure relief system to a non-venting configuration.

19. The method of claim 17, wherein the pressure relief system comprises a valve coupling the delivery line to the return line, and wherein actuating the pressure relief system comprises switching the valve from a closed position to an open configuration.

20. The method of claim 19, wherein actuating a pressure relief system comprises a controller generating a command to actuate the valve.
